(19) United States
(12) Patent Application Publication
(10) Pub. No.: US 2012/0013633 A1
(43) Pub. Date: Jan. 19, 2012

(54) POSITIONING METHOD AND DISPLAY SYSTEM USING THE SAME

(75) Inventors: Shih-Pin Chen, Taoyuan County (TW); Chi-Pao Huang, Taoyuan County (TW); Hsin-Nan Lin, New Taipei City (TW)

(73) Assignee: BENQ CORPORATION, Taipei (TW)

(21) Appl. No.: 13/181,617

(22) Filed: Jul. 13, 2011

(30) Foreign Application Priority Data
Jul. 14, 2010 (TW) 99123215

(51) Int. Cl. G09G 3/22; G09G 5/02

(52) U.S. Cl. 345/589; 345/183

(57) ABSTRACT

A positioning method for obtaining position where a light pen is in contact with a display device at a to-be-positioned spot is provided. The display device includes display areas, corresponding with positioning coding patterns of a built-in positioning frame. The positioning method includes the following steps. Firstly, a positive positioning frame and a negative positioning frame are obtained according to the built-in positioning frame. Next, the positive and the negative positioning frames are respectively added on first original video frames to respectively generate first frame displayed in first frame time and second frame displayed in second frame time. Then the light pen obtains first selected image and second selected image from the first and the second frames respectively. After that, a to-be-positioned pattern is obtained by subtracting the second selected image from the first selected image and a coordinate position of the to-be-positioned spot is obtained.

This application claims the benefit of Taiwan application Serial No. 99123215, filed Jul. 14, 2010, the subject matter of which is incorporated herein by reference.

### BACKGROUND OF THE INVENTION

1. Field of the Invention

The invention relates in general to a positioning method and a display system thereof and more particularly to a positioning method for implementing a touch display system and a display system thereof.

2. Description of the Related Art

With the rapid advance in technology, touch display panels have been developed and widely used in various electronic products. Of the existing technologies, the capacitive touch panel, being a main stream touch display panel, includes a substrate with a transparent electrode. The transparent electrode can sense a touch operation event that a conductor (such as a user's finger) approaches the substrate and correspondingly generates an electrical signal for detection. Thus, the touch display panel can be implemented by means of detecting and converting the electrical signals.

However, the conventional capacitive touch panel normally needs the substrate with a transparent electrode disposed on an ordinary liquid crystal display panel (that is, the ordinary liquid crystal display panel which includes two substrates and a liquid crystal layer interposed between the two substrates). Consequently, the manufacturing process of the conventional capacitive touch panel becomes more complicated and incurs more costs. Thus, how to implement a touch display panel capable of sensing the user's touch operation without using the substrate with a transparent electrode has become a prominent task for the industries.

### SUMMARY OF THE INVENTION

The invention is directed to a positioning method used in a display system. According to the positioning method of the invention, touch function can be implemented on an ordinary display system in the absence of a touch panel. In comparison to the conventional touch display panel, the positioning method of the invention further has the advantages of lower manufacturing complexities and costs.

According to a first aspect of the present invention, a display system for implementing a positioning method for determining the position of a to-be-positioned spot at which a light pen contacts a display device is provided. The display system includes a light pen, a control device and a display device. The display device includes several display areas. The control device has a built-in original coordinate image frame which includes several positioning coding patterns respectively corresponding to the display areas, wherein each of the display areas corresponds to a unique positioning coding pattern. Each unique positioning coding pattern denotes the position coordinates of a corresponding display area. The display device displays a first original video frame for the user to view. The positioning method executed by a control device includes the following steps. Firstly, a positive coordinate image frame and a negative coordinate image frame corresponding to the positive coordinate image frame are generated according to the original coordinate image frame obtained by subtracting the negative coordinate image frame form the positive coordinate image frame. Next, a first display frame is obtained by adding the positive coordinate image frame to the first original video frame. Then, a second display frame is obtained by adding the negative coordinate image frame to the first original video frame. After that, the first and the second display frames are displayed by the display device, and the first and the second fetched images corresponding to the to-be-positioned spot are respectively fetched respectively from the first and the second display frames by the light pen. Afterwards, a to-be-positioned coding pattern is obtained by subtracting the second fetched image from the first fetched image. After that, a positioning coding pattern identical to the to-be-positioned coding pattern is matched among the positioning coding patterns, and the corresponding position coordinates of the identical positioning coding pattern are used as the position coordinates of the to-be-positioned spot.

According to a second aspect of the present invention, a display system for implementing a method for determining the relative displacement of a light pen in contact with a display device is provided. The display device includes several display areas and has a built-in displacement frame. The displacement frame includes several displacement coding patterns arranged in cycles, and the frequency of the displacement coding pattern between any two display areas denotes the interval between the two display areas. The display device displays a second original video frame for the user to view. The positioning method includes the following steps. Firstly, a positive displacement frame and a negative displacement frame corresponding to the positive displacement frame are generated according to a displacement frame obtained by subtracting the negative displacement frame from the positive displacement frame. Then, a third display frame is obtained by adding the positive displacement frame to the second original video frame. Afterwards, a fourth display frame is obtained by adding the negative displacement frame to the second original video frame. After that, the subsequent flow is illustrated in steps (1) to (3). In step (1), during the third frame time period, the third display frame is displayed and the third fetched image is fetched from the third display frame by the light pen. In step (2), during the fourth frame time period, the fourth display frame is displayed, and a fourth fetched image is fetched by the light pen from the fourth display frame. In step (3), a measured pattern is obtained by subtracting the fourth fetched image from the third fetched image. The above steps (1) to (3) are repeated, the light pen fetches several measured patterns, and a measured displacement is generated according to the measured patterns. Afterwards, gravity direction information is generated by the gravity sensing device. After that, a relative displacement of the light pen is generated according to the measured displacement and the gravity direction information.

According to a third aspect of the present invention, a display system for implementing a positioning method for determining the position of a to-be-positioned spot at which a light pen contacts a display device is provided. The display system includes a light pen, a control device and a display device. The display device includes several display areas. The control device has a built-in original coordinate image frame. The original coordinate image frame includes several positioning coding patterns respectively corresponding to the display areas, so that each of the display areas corresponding to the same horizontal position corresponds to a unique positioning coding pattern, which denotes the horizontal coordinate of the corresponding display area. The display device displays the first original video frame for the user to view. The control device executes the positioning method, which includes the following steps. Firstly, a positive coordinate image frame and a negative coordinate image frame corresponding to the positive coordinate image frame are generated according to the original coordinate image frame obtained by subtracting the negative coordinate image frame form the positive coordinate image frame. Next, a first display frame is obtained by adding the positive coordinate image frame to the first original video frame. After that, a second display frame is obtained by adding the negative coordinate image frame to the first original video frame. Afterwards, the first and the second display frames are displayed by the display device, and a first and a second fetched images corresponding to the to-be-positioned spot are fetched from the first and the second display frames by the light pen. Following that, a to-be-positioned coding pattern is obtained by subtracting the second fetched image from the first fetched image. Then, a positioning coding pattern identical to the to-be-positioned coding pattern is matched among the positioning coding patterns, and the corresponding position coordinate of the identical positioning coding pattern is used as the horizontal coordinate of the to-be-positioned spot so as to identify the horizontal coordinate of the to-be-positioned spot corresponding to the to-be-positioned coding pattern. Then, the first image update starting time of the first fetched image (or the second image update starting time of the second fetched image) is sensed. After that, a vertical coordinate of the to-be-positioned spot corresponding to the fetched image is located according to the time relationship between the first image update starting time (or the second image update starting time) and the frame update initial point of the display device.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of a display system according to an embodiment of the invention;

FIG. 2 shows a detailed block diagram of a light pen according to an embodiment of the invention;

FIG. 3 shows a detailed block diagram of a control device according to an embodiment of the invention;

FIGS. 4A and 4B respectively are a state diagram of a positioning method according to an embodiment of the invention;

FIG. 5A shows a display screen according to an embodiment of the invention;

FIG. 5B shows an original coordinate image frame PX according to an embodiment of the invention;

FIGS. 6A to 6D respectively show an illustration of a coding unit according to an embodiment of the invention;

FIGS. 7A and 7B respectively show a coding numeric array and its corresponding coding pattern PX(I,J) according to an embodiment of the invention;

FIGS. 8A to 8D respectively show another illustration of a coding unit according to an embodiment of the invention;

FIG. 9 shows another illustration of a coding pattern PX(I,J) according to an embodiment of the invention;

FIG. 10 shows a detailed flowchart of a initial positioning state 200 according to an embodiment of the invention;

FIGS. 11A to 11D respectively show a positive coordinate image frame PX+, a negative coordinate image frame PX−, an original video frame Fo1 and an original video frame Fo1′ with reduced gray level according to an embodiment of the invention;

FIGS. 11E to 11G respectively show a coordinate video frame Fm1, a coordinate video frame Fm2 and a to-be-positioned coding pattern PW according to an embodiment of the invention;

FIG. 12 shows another detailed flowchart of a initial positioning state 200 according to an embodiment of the invention;

FIG. 13 shows a displacement coding pattern according to an embodiment of the invention;

FIG. 14 shows a detailed flowchart of a displacement calculation state 300 according to an embodiment of the invention;

FIG. 15 shows another detailed block diagram of a control device according to an embodiment of the invention; and

FIG. 16 shows another a block diagram of a display system according to an embodiment of the invention.

### DETAILED DESCRIPTION OF THE INVENTION

In response to a user's touch operation, the positioning method of an embodiment of the invention comprising steps of: (1) some of the positioning coding patterns contained in the image displayed by a display device are fetched by the light pen, and (2) the to-be-positioned spot corresponding to the user's touch operation is determined through image matching of the fetched positioning coding patterns.

The present embodiment of the invention provides a positioning method for determining the position of a to-be-positioned spot at which a light pen contacts a display device. The display device has a plurality of display areas and a built-in original coordinate image frame which includes a plurality of positioning coding patterns. Each display area corresponds to a unique positioning coding pattern which denotes the position coordinates of the corresponding display area. When delivering the original coordinate image frame for the light pent to fetch, the display device also need to display a first original video frame for the user to watch.

The positioning method includes the following steps. Firstly, based on the original coordinate image frame, a positive coordinate image frame and a negative coordinate image frame corresponding to the positive coordinate image frame are generated. For example, by subtracting the negative coordinate image frame from the positive coordinate image frame, the residual is equivalent to the original coordinate image frame. Next, a first coordinate video frame is generated by adding the positive coordinate image frame and the first original video frame. Similarly, a second coordinate video frame is generated by adding the negative coordinate image frame and the first original video frame.

During a first frame time period, the first display frame is displayed by the display device, and a first fetched image corresponding to the to-be-positioned spot is fetched from the first display frame by the light pen. During a second frame time period, the second display frame is displayed by the display device, and a second fetched image corresponding to the to-be-positioned spot is fetched from the second display frame by the light pen.

Then, a to-be-positioned coding pattern is obtained by subtracting the second fetched image from the first fetched image. After that, by searching the plurality of positioning coding patterns contained in the original coordinate image frame, only one positioning coding pattern identical to the to-be-positioned coding pattern is matched from the plurality of positioning coding patterns, and the corresponding position coordinates of the identical positioning coding pattern are used as the position coordinates of the to-be-positioned spot. An exemplary embodiment is disclosed below for exemplification purpose.

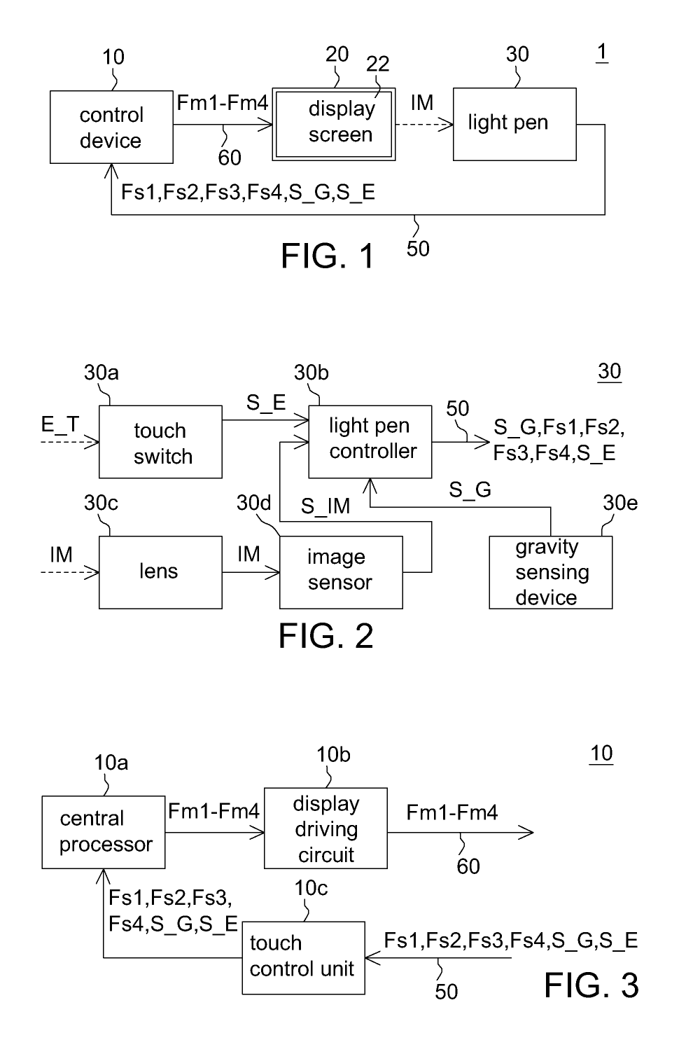

Referring to FIG. 1, a block diagram of a display system according to an embodiment of the invention is shown. The display system 1 includes a control device 10, a display device 20 and a light pen 30. The display device 20 includes a display screen 22, such as a liquid crystal display (LCD) screen. In the FIG. 1 embodiment, the control device 10 is disposed outside the display device 20 (Ex: in a personal computer), so the display device 20 can communicate with the control device 10 via a video transmission interface 60 such as an analog video graphic array (VGA), a digital visual interface (DVI) or a high definition multimedia interface (HDMI). The light pen 30 is connected to the control device 10 via a device bus 50 such as a universal serial bus (USB). In another embodiment (not shown), the control device 10 is disposed within the display device 20, so an internal data bus of the display device 20 can act as the video transmission interface 60 between the control device 10 and the display screen 22.

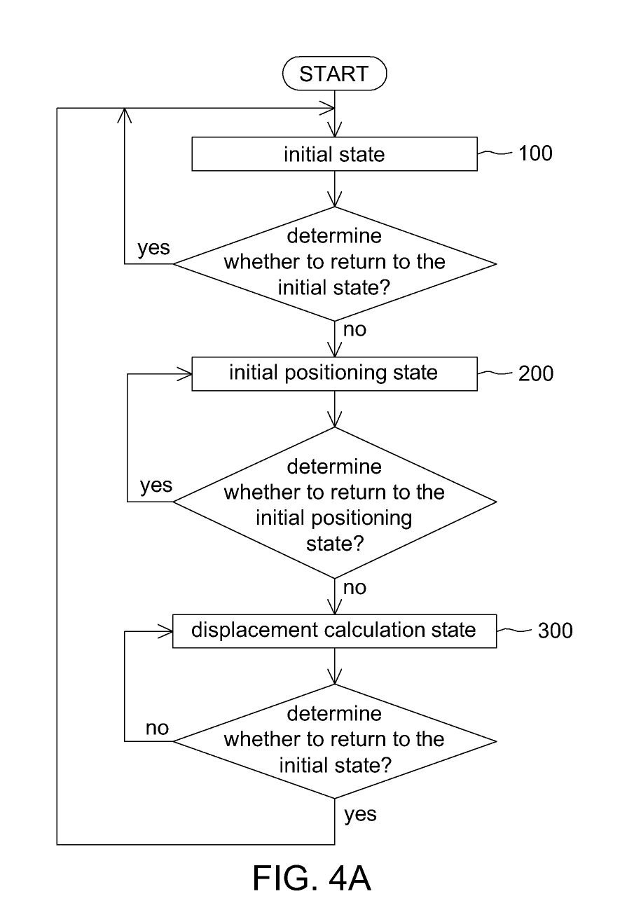

Referring to FIG. 2, a detailed block diagram of a light pen according to an embodiment of the invention is shown. The light pen 30 includes a touch switch 30a disposed at the tip of the light pen 30, a light pen controller 30b, a lens 30c and an image sensor 30d. The lens 30c makes an image IM shown on the display screen 22 focused on the image sensor 30d, so that the image sensor 30d can provide an image signal S_IM. The touch switch 30a responds to the user's touch operation E_T by providing an enabling signal S_E. When receiving the enabling signal S_E, the light pen controller 30b activates the image sensor 30d, so that the lens 30c and the image sensor 30d can generate the image signal S_IM according to the image IM. The light pen controller 30b receives the image signal S_IM and further provides the image signal S_IM to the control device 10 via the device bus 50.

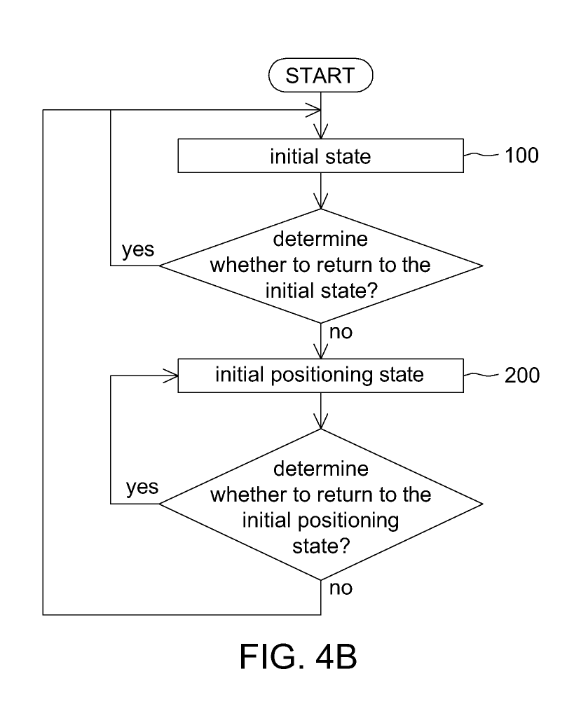

Referring to FIG. 3, a detailed block diagram of a control device according to an embodiment of the invention is shown. For example, the control device 10, which can be implemented by a personal computer, includes a central processor 10a, a display driving circuit 10b and a touch control unit 10c. The display driving circuit 10b and the touch control unit 10c both connected to the central processor 10a are controlled by the central processor 10a to perform corresponding operations. The touch control unit 10c, such as a device bus controller, receives the operation information sent back from the light pen 30 via the device bus 50, and further provides the operation information to the central processor 10a. The display driving circuit 10b drives the display device 20 via the video transmission interface 60 to display a corresponding display frame.

The central processor 10a, as a key component of the display system 1, implements the positioning method by controlling the display device 20 to display images and controlling the light pen 30 to fetch the images displayed by the display device 20. The positioning method executed by the control device 10 is disclosed below.

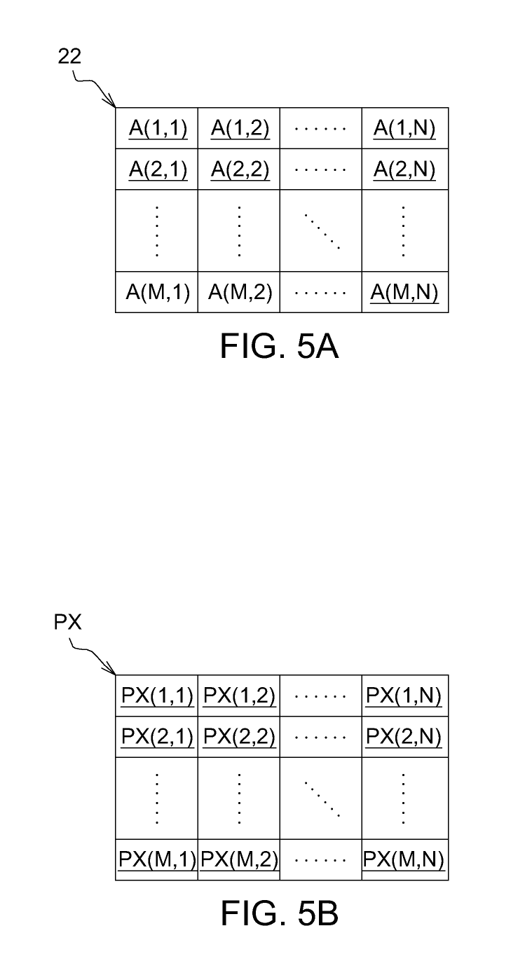

Referring to FIG. 4A, a state diagram of a positioning method according to an embodiment of the invention is shown. For example, the control device 10 performing the positioning method of the invention includes an initial state 100, an initial positioning state 200 and a displacement calculation state 300.

Initial State 100

Whenever the tip of the light pen 30 does not touch the display screen 22, the control device 10 is in the initial state 100, and then whether the user makes the light pen touch the display screen 22 is continuously monitored. Thus, in the initial state 100, the central processor 10a continuously detects whether an enabling signal S_E is received so as to determine whether the light pen 30 should enter the initial positioning state 200.

Before the central processor 10a receives the enabling signal S_E, this implies that the user has not yet performed the touch operation E_T. Thus, the positioning method executed by the central processor 10a remains at the initial state 100. Meanwhile, the display device 20 only displays the first original video frame, and does not need to display the first display frame (adding the positive coordinate image frame and the first original video frame) and the second display frame (adding the negative coordinate image frame and the first original video frame).

When the central processor 10a receives the enabling signal S_E, this implies that the user grips the light pen 30 and makes the light pen 30 touch the display screen 22 to perform a touch operation E_T. Meanwhile, the control device 10 exits the initial state 100 and enters the initial positioning state 200. The display device 20 keeps alternatively displaying the first coordinate video frame (obtained by adding the positive coordinate image frame to the original video frame), and the second coordinate video frame (obtained by adding the negative coordinate image frame to the original video frame); so as to identify the position at which the tip of the light pen 30 touches the display screen 22.

Based on the enabling signals S_E, the central processor 10a determines whether to exit the initial state 100 and enter the initial positioning state 200. For example, the enabling signal S_E is generated according to the contact state of the light pen tip with the touch switch 30a. After the touch switch 30a changes to the “touch state” from the “non-touch state” and has remained at the “touch state” for more than a predetermined time period, the control device 10 and the display device 20 exit the initial state 100 and enter the initial positioning state 200.

Except the enabling signal S_E, the control device 10 may also include the imaging result of the image sensor 30d as a factor to determine whether to exit the initial state 100 and enter the initial positioning state 200. For example, when the image sensor 30d determines that the image received from the display device 20 becomes a clear image successfully focused on the image sensor 30d, and that clear image has been successfully focused on the image sensor 30d for more than a predetermined time period, the control device 10 and the display device 20 exit the initial state 100 and enter the initial positioning state 200.

Initial Positioning State 200

In the initial positioning state 200, the control device 10 keeps the display device 20 alternatively displaying the first and the second coordinate video frames which contain the original coordinate image frame information. By analyzing the image fetched by the light pen 30, the control device 10 can perform an initial positioning operation on the to-be-positioned spot at which the light pen 30 contacts the display screen 22. Thus, the user can perform a touch operation on the display device 20 with the light pen 30 later.

Initial Positioning State 200—Coordinate Image Frame

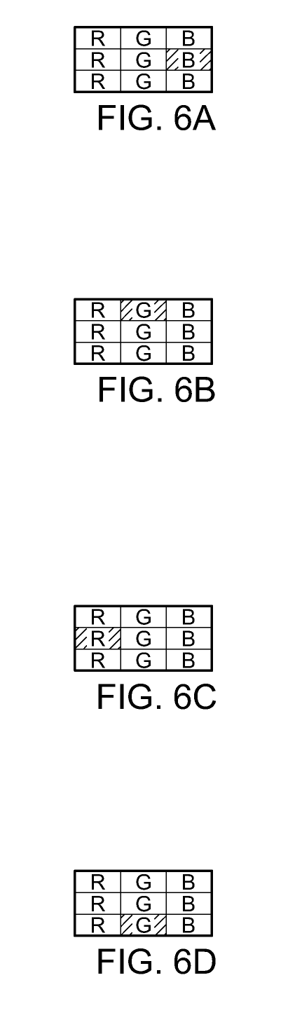

The control device 10 has an original coordinate image frame PX, which includes several independent positioning coding patterns respectively corresponding to the display areas of the display screen 22. Each display area of the display screen 22 corresponds to a unique positioning coding pattern which denotes the position coordinates of a corresponding display area, i.e., each positioning coding pattern is only assigned to one display area. For example, if the display screen 22 includes M×N display areas A(1,1), A(1,2), . . . , A(1,N), A(2,1), A(2,2), . . . , A(2,N), A(M,1), A(M,2), . . . , A(M,N), then the original coordinate image frame PX has M×N positioning coding patterns PX(1,1), PX(1,2), . . . , PX(1,N), PX(2,1), PX(2,2), . . . , PX(2,N), PX(M,1), PX(M,2), . . . , PX(M,N) respectively corresponding to the M×N display areas A(1,1) to A(M,N) illustrated in FIG. 5A and 5B, wherein M and N both are a natural number larger than 1.

For the coding patterns PX (1,1) to PX(M,N), each coding pattern can be denoted by the data of several pixels according to a particular coding method. For example, the coding method for the coding patterns PX(1,1) to PX(M,N) used in the present embodiment of the invention may utilize the two dimensional coordinate coding method disclosed in the U.S. Pat. No. 6,502,756.

For example, as an embodiment described by the FIG. 5 and related written description (line 46 of column 15 to line 39 of column 16) of the U.S. Pat. No. 6,502,756, each of the coding patterns PX(1,1) to PX(M,N) may include 16 coding units arranged in a 4×4 matrix, and each of the coding patterns units selectively represents one of the coding values selected from the group of 1, 2, 3 and 4.

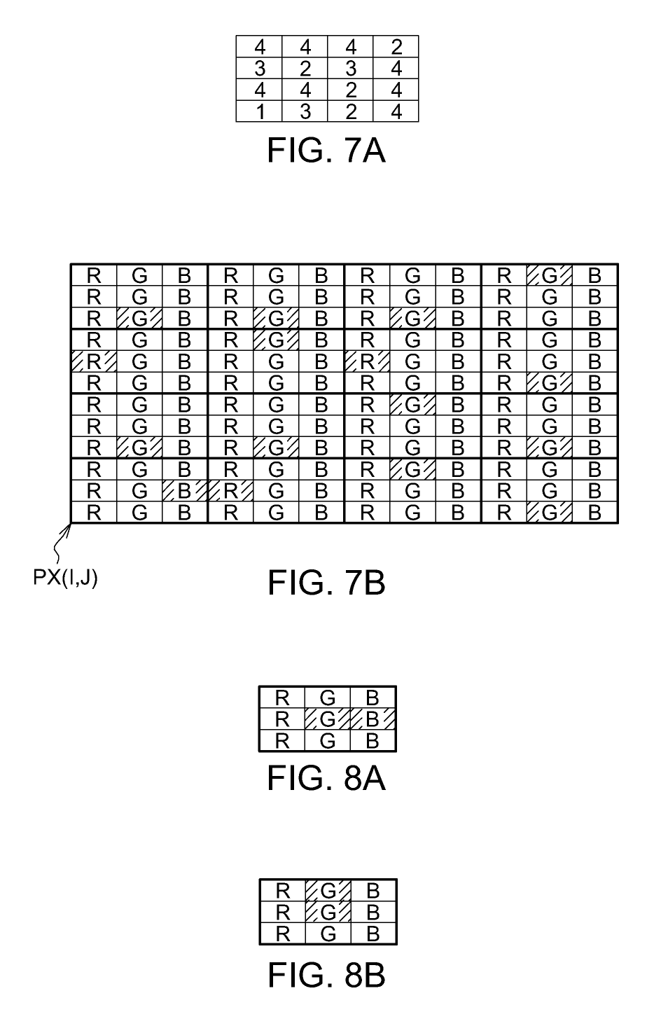

Referring to FIGS. 6A to 6D, four coding units proposed in this invention representing four different coding values are respectively shown. For example, each coding unit is formed by three adjacent pixels (each pixel contains an R color sub-pixel, a G color sub-pixel, and a B color sub-pixel), that is, each coding unit is a 3×3 matrix (3 by 3 matrix with nine cells) formed by nine adjacent sub-pixels. At least one sub-pixel in each 3×3 matrix is assigned with a particular gray level, and the coding value of each coding unit is determined by where the sub-pixel assigned with particular gray level is located (middle right, middle left, upper middle, or lower middle). For example, the value of the particular gray level is 28.

In FIGS. 6A to 6D, only one sub-pixel in each 3×3 matrix is assigned with a particular gray level. By changing the relative position of the sub-pixel with particular gray level in the matrix, the coding value of each coding unit (1, 2, 3 or 4) is determined. In the example of the coding unit illustrated in FIGS. 6A to 6D, the 3×3 matrix includes 9 sub-pixels, and the sub-pixel with particular gray level is in slashed lines.

For the coding unit illustrated in FIG. 6A, the sub-pixel with particular gray level is located at the middle right of the 3×3 matrix coding unit. In the present example, the coding unit illustrated in FIG. 6A represents the coding value 1.

For the coding unit illustrated in FIG. 6B, the sub-pixel with particular gray level is located at the upper middle of the 3×3 matrix coding unit. In the present example, the coding unit illustrated in FIG. 6B represents the coding value 2.

For the coding unit illustrated in FIG. 6C, the sub-pixel with particular gray level is located at the middle left of the 3×3 matrix coding unit. In the present example, the coding unit illustrated in FIG. 6C represents the coding value 3.

For the coding unit illustrated in FIG. 6D, the sub-pixel with particular gray level is located at the lower middle of the 3×3 matrix coding unit. In the present example, the coding unit illustrated in FIG. 6D represents the coding value 4.

Thus, following the embodiment described in the U.S. Pat. No. 6,502,756, each of the coding patterns PX(1,1) to PX(M,N) includes 16 coding units arranged in a 4×4 matrix, and the coding units representing different coding values are illustrated by FIGS. 6A to 6D.

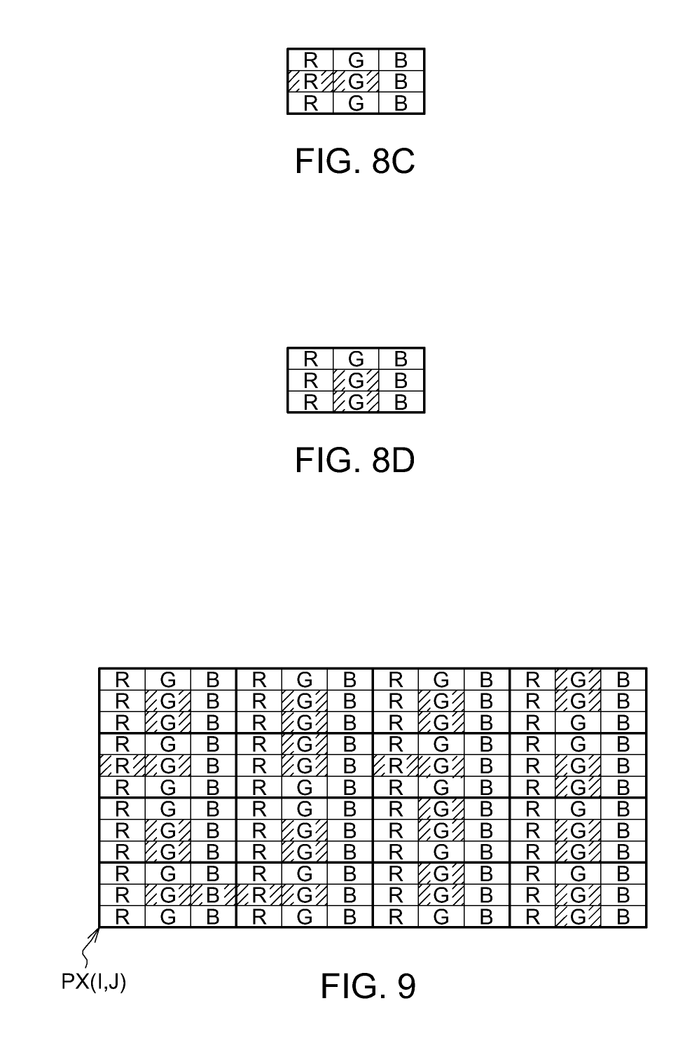

As illustrated in FIG. 7A, the coding pattern PX(I,J) (I and J are natural numbers, I<=M, and J<=N) has 16 coding units arranged in a 4×4 matrix, and the coding values denoted by the coding units of each row are respectively same as the embodiment described in the U.S. Pat. No. 6,502,756, i.e., (4,4,4,2), (3,2,3,4), (4,4,2,4) and (1,3,2,4). When using the coding units illustrated in FIGS. 6A to 6D, the sub-pixel array corresponding to the complete coding pattern PX(I,J) will be as illustrated in FIG. 7B.

By assigning each of the M×N positioning coding patterns PX(1,1) to PX(M,N) with a unique combination of coding values, the control device 10 can assign a particular positioning coding pattern to each of the display areas of the display screen 22 to denote the position coordinates of the corresponding display area. Thus, each of the display areas A(1,1) to A(M,N) illustrated in FIG. 5A corresponds to a group of independent coordinate information.

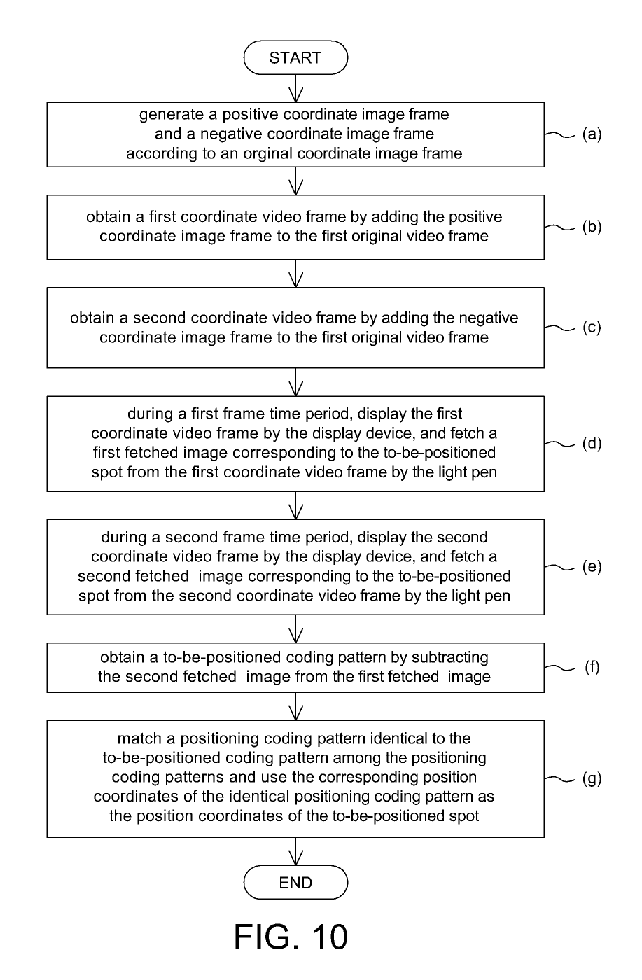

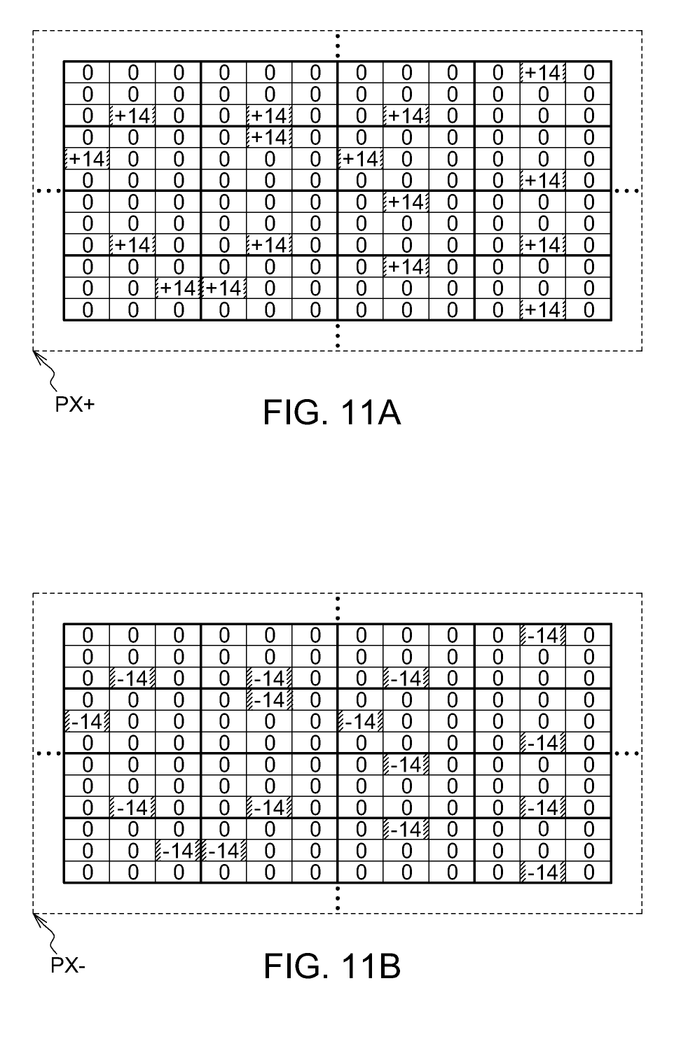

In the present embodiment of the invention, the M×N positioning coding patterns PX(1,1) to PX(M,N) has a 3×3 matrix as illustrated in FIG. 7B. However, the positioning coding patterns of the present embodiment of the invention are not limited to the above exemplification. For example, another embodiment of the coding units representing different coding values (that is, 1, 2, 3, and 4) are illustrated in FIGS. 8A to 8D, wherein the central sub-pixel of each coding patterns unit also assigned with the particular gray level (in slashed lines). Suppose the coding pattern PX(I,J) has 16 coding units arranged in a 4×4 matrix, the coding values denoted by the coding units of each row are respectively (4,4,4,2), (3,2,3,4), (4,4,2,4) and (1,3,2,4) as illustrated in FIG. 7A. When using the coding units illustrated in FIGS. 8A to 8D the sub-pixel array corresponding to the coding pattern PX(I,J) will be as illustrated in FIG. 9.

In the present embodiment of the invention, each positioning coding pattern PX(I,J) is exemplified by a 4×4 matrix of coding units or a 12×12 matrix of sub-pixels. However, the positioning coding patterns PX(1,1) to

PX(M,N) are not limited to the above exemplification, and may include a smaller or larger matrix of sub-pixels.

In the present embodiment of the invention, each of the M×N positioning coding patterns PX(1,1) to PX(M,N) is exemplified by a 3×3 matrix pattern as illustrated in FIG. 7B or FIG. 9, and is adopted to implement the two dimensional coordinate coding method disclosed in the U.S. Pat. No. 6,502,756. However, the positioning coding patterns of the present embodiment of the invention are not limited to the above exemplification and can further be implemented by other array bar code patterns. For example, the positioning coding patterns of the present embodiment of the invention can be implemented by a two dimensional array bar code such as QR code.

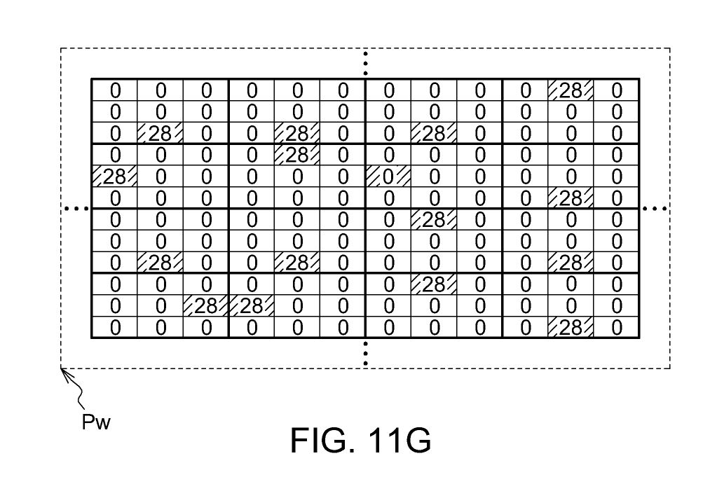

In the present embodiment of the invention, each of the M×N positioning coding patterns PX(1,1) to PX(M,N) carries two dimensional coordinate information. However, the positioning coding patterns of the present embodiment of the invention are not limited to the above exemplification. In an alternative example, each of the M×N positioning coding patterns PX(1,1) to PX(M,N) only carries one dimensional coordinate information such as one dimensional coordinate information in horizontal direction. In other words, among those M×N positioning coding patterns PX(1,1) to PX(M,N), when they correspond to the same horizontal position (such as the positioning coding patterns PX(1,1), PX(2,1), PX(3,1), . . . , PX(M,1)), the M×N positioning coding patterns PX(1,1) to PX(M,N) exactly correspond to the same positioning coding pattern. Thus, in the course of the positioning operation, the control device 10 needs to rely extra information to achieve a complete two dimensional positioning operation, and one embodiment about how to complete the two dimensional positioning operation based on the M×N positioning coding patterns carrying only one dimensional coordinate information is illustrated in FIG. 12.

Initial Positioning State 200—Detailed Flow

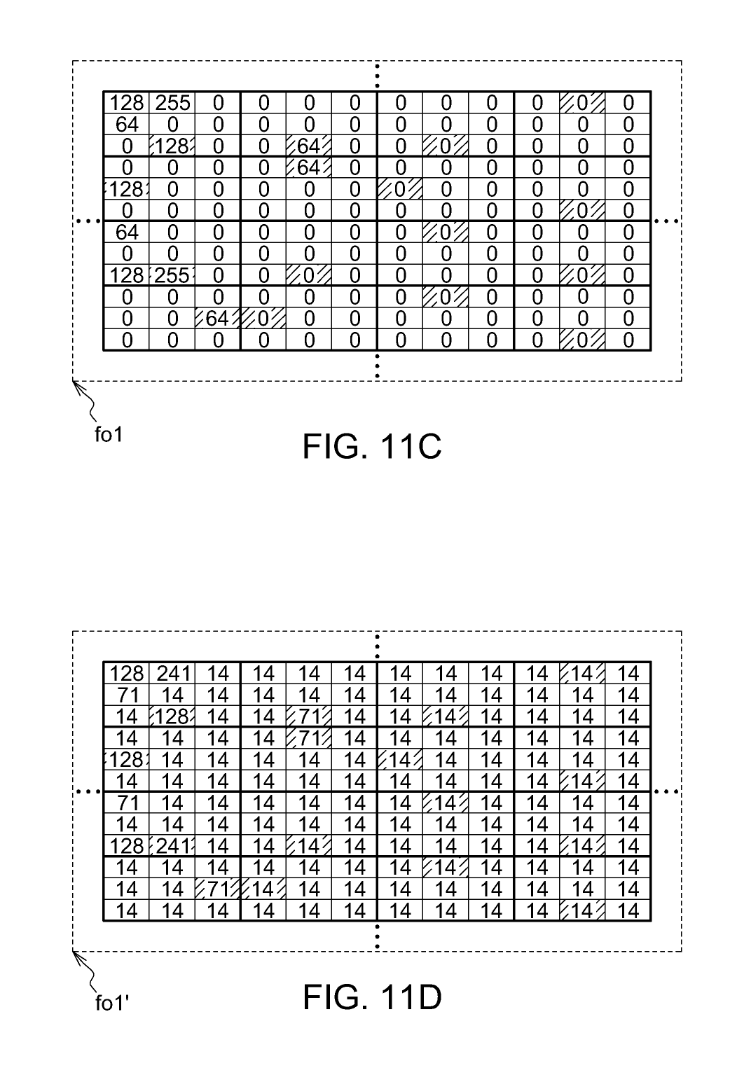

Referring to FIG. 10, a detailed flowchart of steps performed in the initial positioning state 200 according to an embodiment of the invention is shown. The state 200 includes steps (a) to (g). Firstly, as indicated in step (a), the central processor 10a generates a positive coordinate image frame PX+ and a negative coordinate image frame PX− based on the original coordinate image frame PX illustrated in FIG. 5B, wherein the positive coordinate image frame PX+ and the negative coordinate image frame PX− are generated in pair.

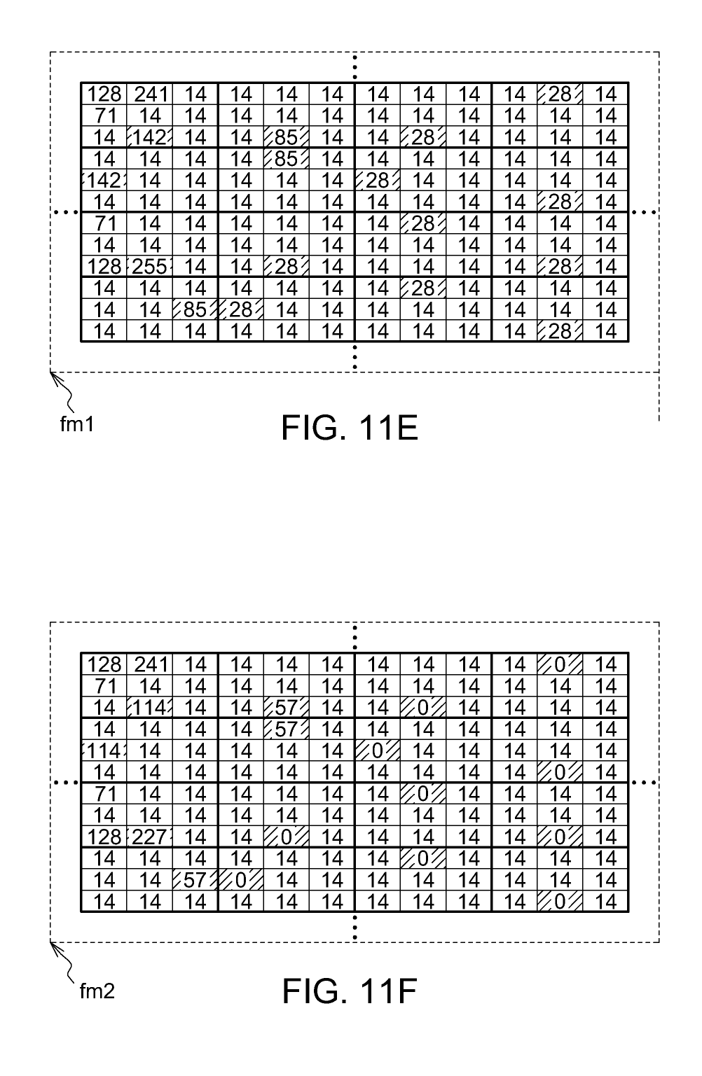

Corresponding to those sub-pixels designated to be assigned with particular gray level in the original coordinate image frame PX, the same sub-pixels in the positive coordinate image frame PX+ are set as “gray level +14”. Thus, when the positive coordinate image frame PX+ is added to the original video frame later, the grey levels of the sub-pixel data corresponding to the original video frame will be added by 14. FIG. 11A shows the gray level of a to-be-positioned spot AW within the positive coordinate image frame PX+, and assuming the to-be-positioned spot AW is assigned with a coding pattern PX+(X,Y) shown in FIG. 7B.

Corresponding to those sub-pixels designated to be assigned with particular gray level in the original coordinate image frame PX, the same sub-pixels in the negative coordinate image frame PX− are set as “gray level −14”. Thus, when the negative coordinate image frame PX− is added to the original video frame latter, the grey levels of the sub-pixel data corresponding to the original video frame will be subtracted by 14. FIG. 11B shows the gray level of a to-be-positioned spot AW within the negative coordinate image frame PX−, and assuming the to-be-positioned spot AW is assigned with a coding pattern PX+(X,Y) shown in FIG. 7B.

Thus, the original coordinate image frame PX illustrated in FIG. 5B is equivalent to the residual when subtracting the sub-pixel data of the negative coordinate image frame PX− from the sub-pixel data of the positive coordinate image frame PX+ for each sub-pixel data of the positive and the negative coordinate image frames that corresponds to the same position.

In the display system 1, the control device 10 may receive the original video frame Fo1 from an external video signal source, or itself may generate the original video frame Fo1. Before implementing current invention, the original video frame Fo1 is supplied from the control device 10 to the display device 20, and then is displayed on the display screen 22. For example, as part of the original video frame Fo1, the gray levels of the sub-pixels of the to-be-positioned spot AW are illustrated in FIG. 11C. Next, as illustrated in FIG. 10 step (b), the central processor 10a adds the positive coordinate image frame PX+ to the original video frame Fo1 to generate a first coordinate video frame Fm1. Then, as illustrated in FIG. 10 step (c), the central processor 10a adds the negative coordinate image frame PX− to the original video frame Fo1 to generate a second coordinate video frame Fm2.

It is preferred that the original video frame Fo1, the first coordinate video frame Fm1, and the second coordinate video frame Fm2 all use the same number of gray level bits, i.e., it is unnecessary to add more bits for representing the gray level of the first coordinate video frame Fm1, and the second coordinate video frame Fm2. Therefore, before adding the positive coordinate image frame PX+ or the negative coordinate image frame PX− to the original video frame Fo1, the central processor 10a, first of all, reduces the range in gray level of the pixels of the original video frame Fo1, so that the first coordinate video frames Fm1 and the second coordinate video frame Fm2 obtained by adding another frame thereto will be free of gray level overflow or negative gray level.

For example, assuming the original gray level of the original video frame Fo1 is denoted by 8 gray level bits, that is, the original gray level range of the original video frame Fo1 is from 0 to 255 (=2⁸−1). Before steps (b) and (c), the central processor 10a makes the gray level range of the original video frame Fo1 linearly reduced to the range of from 14 to 241 ((0+14) to (255−14)), I.e., the highest gray level of the original video frame Fo1 now is reduced to gray level 241, and the lowest gray level of the original video frame Fo1 now is creased to gray level 14. Thus, either adding the original video frame Fo1 (whose MAX gray level=241) with the positive coordinate image frame PX+ (whose MAX gray level=14), or adding the original video frame Fo1 (whose min gray level=14) with the negative coordinate image frame PX− (whose min gray level=−14), the obtained sub-pixel data is still within the range of 0 to 255 that can be denoted with 8 bits.

In the reduced original video frame Fo1′, corresponding to the to-be-positioned spot AW illustrated in FIG. 11C, the reduced gray levels for the to-be-positioned spot AW are illustrated in FIG. 11D. After linearly reduction, all sub-pixel data of the reduced original video frame Fo1′ is within the range of 14 to 241. The gray level range of the original video frame Fo1 can be linearly reduced to the range of 14 to 241 from the range of 0 to 255 according to the following formula: the linearly reduced gray level=14+(original gray level/255)*(241−14). If the original gray level equals 64, then the reduced gray level is about 70.9 and then is rounded off to the integer as 71. If the original gray level=255, then the reduced gray level equals 241.

However, if it allows adding extra gray level bit for implementing this invention, then the linear reduction process is unnecessary. For example, assuming the original gray level of the original video frame Fo1 is denoted by 8 bits, that is, the original gray level range is from 0 to 255. In order to implement current invention, the number of gray level bits is increased to 9 bits, and the original gray level range (from 0 to 255) is shifted to the gray level range (from 14 to 269) of the reduced original video frame Fo1′, so no linear reduction process is performed.

Next, the flow proceeds to step (b), the positive coordinate image frame PX+ (portion corresponding to the to-be-positioned spot AW is shown in FIG. 11A) is added to the reduced original video frame Fo1′ (portion corresponding to the to-be-positioned spot AW is shown in FIG. 11D) to generate a first coordinate video frame Fm1. The gray levels of the to-be-positioned spot AW of the first coordinate video frame Fm1 are illustrated in FIG. 11E.

Then, the flow proceeds to step (c), the negative coordinate image frame PX− (portion corresponding to the to-be-positioned spot AW is shown in FIG. 11B) is added to the reduced original video frame Fo1′ (portion corresponding to the to-be-positioned spot AW is shown in FIG. 11D) to generate a second coordinate video frame Fm2. The gray levels of the to-be-positioned spot AW of the second coordinate video frame Fm2 are illustrated in FIG. 11F.

After that, the flow proceeds to step (d), during the first frame time period, the central processor 10a makes the display device 20 display the first coordinate video frame Fm1; meanwhile, the light pen 30 is positioned at the to-be-positioned spot AW. Thus, the light pen 30 can correspondingly fetch a first fetched image Fs1 being a 12×12 matrix of sub-pixels as illustrated in FIG. 11E from the first coordinate video frame Fm1.

Afterwards, the flow proceeds to step (e), during the second frame time period next to the first frame time period, the central processor 10a makes the display device 20 display the second coordinate video frame Fm2; meanwhile, the light pen 30 is still positioned at the to-be-positioned spot AW. Thus, the light pen 30 can correspondingly fetch a second fetched image Fs2 being a 12×12 matrix of sub-pixels as illustrated in FIG. 11F from the second coordinate video frame Fm2.

Following that, the flow proceeds to step (f), the central processor 10a receives the fetched images Fs1 and Fs2 fetched by the light pen 30 via the touch control unit 10c and further subtracts the second fetched image Fs2 from the first fetched image Fs1 to generate a to-be-positioned coding pattern PW. For example, each of the fetched images Fs1 and Fs2 includes a 12×12 matrix of sub-pixels. The first fetched image Fs1 is a 12×12 matrix of sub-pixels of a to-be-positioned spot of the first coordinate video frame Fm1, and should have values illustrated in FIG. 11E. The second fetched image Fs2 is a 12×12 matrix of sub-pixels of a to-be-positioned spot of the coordinate video frame Fm2, and should have values same as illustrated in FIG. 11F. The central processor 10a generates a to-be-positioned coding pattern PW according to a difference in gray level between corresponding pixels of the first fetched image Fs1 and the second fetched image Fs2. Therefore, by subtracting the second fetched image Fs2 (whose values illustrated in FIG. 11F) from the first fetched image Fs1 (whose values illustrated in FIG. 11E), the resulted to-be-positioned coding patterns PW are illustrated in FIG. 11G.

Then, the flow proceeds to step (g), the central processor 10a matches the positioning coding pattern identical to the to-be-positioned coding pattern PW of FIG. 11G among the positioning coding patterns PX(1,1) to PX(M,N) of the original coordinate image frame of FIG. 5B. Sine each of the positioning coding patterns PX(1,1) to PX(M,N) is uniquely coded according to the two dimensional coordinate coding disclosed in the U.S. Pat. No. 6,502,756, each positioning coding pattern carries two dimensional coordinate information. Thus, the central processor 10a can locate the position coordinates of the to-be-positioned spot AW through the above matching.

Referring to FIG. 12, another detailed flowchart of an initial positioning state 200 according to an embodiment of the invention is shown. In an alternative example, the positioning coding patterns PX(1,1) to PX(M,N) only carry one dimensional coordinate information in horizontal direction. Thus, in step (g′), the central processor 10a can only locate the horizontal coordinate of the to-be-positioned spot AW according to a to-be-positioned coding pattern through matching. In order to achieve a complete two-dimensional positioning operation on the to-be-positioned spot AW, the positioning information in vertical direction needs to rely on extra information.

For example, if the display device 20 is a LCD display, then the gray levels of the video frame is updated (refreshed) scan line by scan line sequentially top to the bottom in response to the vertical synchronization signals received during the video frame time period. The time relationship between the frame update starting time Tfu of the coordinate video frame Fm1 and the image update start time Tiu of the first fetched image Fs1 is related to the vertical position where the first fetched image Fs1 is located in the first coordinate video frame Fm1. Thus, the central processor 10a can determine the vertical position of the first fetched image Fs1 based on the relationship between the image update starting time Tiu of the first fetched image Fs1 and the frame update starting time Tfu of the first coordinate video frame Fm1. Similarly, the central processor 10a can determine the vertical position of the second fetched image Fs2 based on the relationship between the image update starting time of the second fetched image Fs2 and the frame update starting time Tfu of the second coordinate video frame Fm2.

In step (h′), the central processor 10a locates the image update starting time of the first and second fetched image Fs1/Fs2. Next, in step (i′), based on (1) the delay between the image update starting time Tiu (first row pixels of the first fetched image Fs1 are updated) and the frame update starting time Tfu (first scan line pixels of the corresponding first coordinate video frame Fm1 are updated), (2) the update period of the first coordinate video frame Fm1, the central processor 10a determines the vertical position of the first fetched image Fs1. For example, if the 1024 horizontal scan lines of the first coordinate video frame Fm1 are periodically updated once in every 16 msec, then the update period of the first coordinate video frame Fm1 is 16 msec. Besides, if the image update starting time Tiu of the first fetched image Fs1 is 8 msec later than the frame update starting time Tfu of the first coordinate video frame Fm1 which the first fetched image Fs1 is fetched from. Then, based on the calculation: 1024*(8 msec/16 msec)=512, it is determined that the vertical coordinate of the first row pixel of the first fetched image Fs1 is located at the 512-th horizontal scan line.

Thus, the positioning coding pattern PX(X,Y) determines the horizontal coordinate, and the image update starting time Tiu of the first fetched image Fs1/Fs2 determines the vertical coordinate. In the state 200, the central processor 10a can complete the initial positioning operation on the to-be-positioned spot at which the light pen 30 contacts the display screen 22.

Referring to FIG. 4, after the operation steps of the state 200 for performing the initial positioning operation on the to-be-positioned spot AW are completed, the positioning method executed by the central processor 10a exits the state 200 and enters the state 300. Before the absolute position coordinate of the to-be-positioned spot AW determined, the central processor 10a will remain in the state 200 to perform the initial positioning operation.

In the present embodiment of the invention, the coordinate image frames PX+ and PX− are respectively added to the original video frame Fo1, and then the coordinate video frames Fm1 and Fm2 carrying the coordinate image frame information are displayed alternately and consecutively. However, the positioning method of the present embodiment of the invention is not limited to the above exemplification, and the coordinate video frame information can be fetched by the light pen by other methods. In an alternative example, during a newly inserted frame time period which the display device 20 stops displaying the original video frame Fo1, the control device 10 makes the display device 20 display the coordinate image frame PX or the positive/negative coordinate image frame PX+/PX−, so that the light pen 30 can directly read the coordinate image frame PX or the change between the positive/negative coordinate image frames rather than displaying the display frame formed by adding the coordinate image frame to the original video frame.

In the present embodiment of the invention, the central processor 10a, after completing the initial positioning operation, controls the positioning method to exit the state 200 and enter the state 300. However, the central processor 10a of an embodiment of the invention is not limited to the above exemplification, and may alternatively determine the switch from the state 200 to the state 300 according to other operation events.

In an example, the central processor 10a references the time length for which the touch switch 30a is in the “touch state”. After the touch switch 30a has remained at the “touch state” for more than a predetermined time period, the central processor 10a determines that within this predetermined time period, the central processor 10a should have sufficient computation time to complete the initial positioning operation of the state 200. Thus, after the touch switch 30a has remained at the “touch state” for more than the predetermined time period, the central processor 10a controls the positioning method to exit the state 200 and enter the state 300.

In another example, when the central processor 10a determines that the display device 30 has remained at the state that “image successfully focused on the image sensor 30d” for more than a predetermined time period, the central processor 10a determines that within this predetermined time period, the central processor 10a should have sufficient computation time to complete the initial positioning operation of the state 200, and correspondingly controls the positioning method to exit the state 200 and enter the state 300.

Displacement Calculation State 300

Referring to FIG. 4. When exiting the initial positioning state 200, the control device 10 has already completed the initial positioning operation for determining the absolute coordinates of the to-be-positioned spot AW where the light pen 30 contacts the display screen 22. Next, whenever the control device 10 is in the displacement calculation state 300 and the light pen 30 continuously touching the display screen 22, the control device 10 performs another operation to determine the relative displacement of the to-be-positioned spot AW on the display screen 22.

Displacement Calculation State 300—Displacement Frame

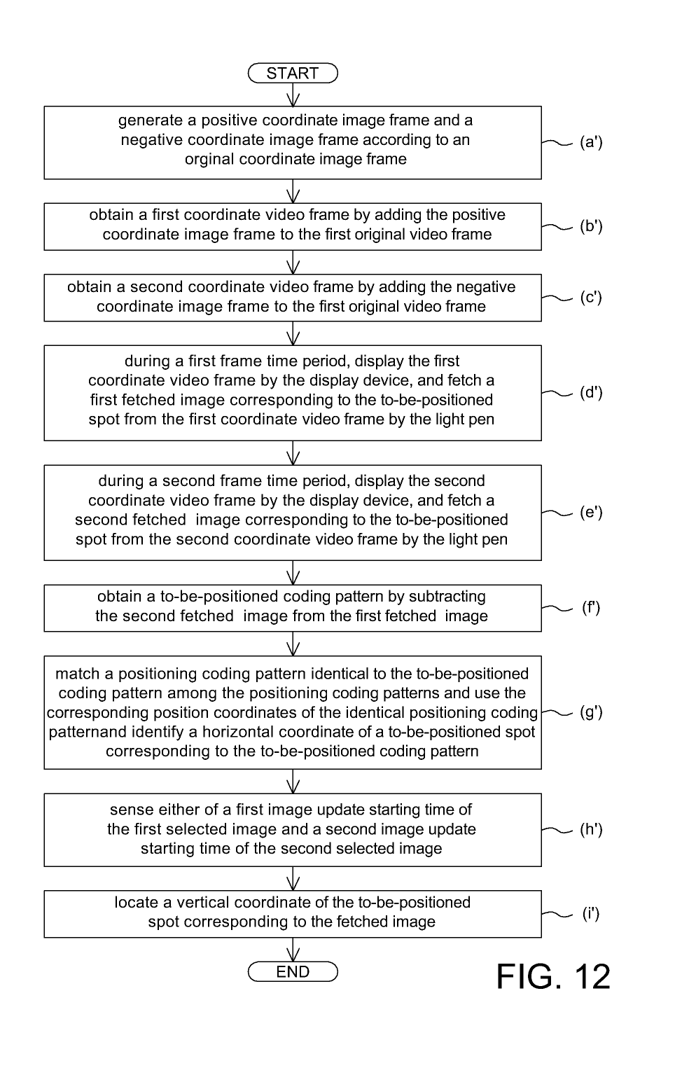

The control device 10 has a built-in displacement frame PP. The light pen 30 further includes a gravity sensing device 30e for sensing the acceleration direction applied on the light pen when the user operates the light pen 30, so as to generate gravity direction information S_G. The displacement frame PP includes several displacement coding patterns arranged repeatedly, wherein the number of the displacement coding patterns detected between any two display areas denotes the distance between the two display areas. For example, as illustrated in FIG. 13, the displacement coding pattern may be a black and white interlaced chessboard. In an odd-numbered column, the even-numbered row sub-pixel data and the odd-numbered row sub-pixel data respectively correspond to gray level 28 and gray level 0. In an even-numbered column, the even-numbered row sub-pixel data and the odd-numbered row sub-pixel data respectively correspond to gray level 0 and gray level 28.

State 300—Detailed Flow

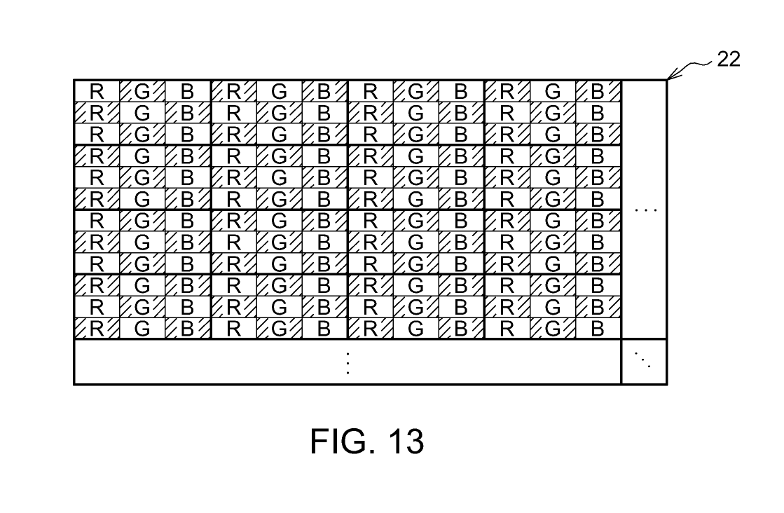

Referring to FIG. 14, a detailed flowchart of a displacement calculation state 300 according to an embodiment of the invention is shown. Firstly, the flow begins at step (a″), the central processor 10a generates a positive displacement frame PP+ and a negative displacement frame PP−, corresponding to the positive displacement frame. By subtracting the negative displacement frame PP− from the positive displacement frame PP+, the result is equivalent to the displacement frame PP. For example, based on the displacement frame PP shown in the FIG. 13, the central processor 10a generates a positive displacement frame PP+ by setting the sub-pixels (for example: odd-numbered column, even-numbered row sub-pixels) with particular gray level data of the displacement frame PP as gray level 14 and maintaining the sub-pixels (for example: odd-numbered column, odd-numbered row sub-pixels) with gray level 0. The central processor 10a generate a negative displacement frame PP− by setting the sub-pixels (for example: odd-numbered column, even-numbered row sub-pixels) with particular gray level data of the displacement frame PP as gray level −14 and maintaining the sub-pixels (for example: odd-numbered column, odd-numbered row sub-pixels) with gray level 0.

Next, the flow proceeds to step (b″) and (c″) similar to steps (b) and (c) of FIG. 10, the central processor 10a generates a first displacement video frame Fm3 by adding the positive displacement frame PP+ to the reduced original video frame Fo1′; and generates a second displacement video frame Fm4 by adding the negative displacement frame PP− to the reduced original video frame Fo1′.

Then, the flow proceeds to step (d″), the central processor 10a makes the display device 20 display the first displacement video frame Fm3 during the third frame time period, so that the light pen 30 can correspondingly fetch a third fetched image Fs3 from the first displacement video frame Fm3. After that, the flow proceeds to step (e″), the central processor 10a makes the display device 20 display a second displacement video frame Fm4 during the fourth frame time period, so that the light pen 30 can correspondingly fetch a fourth fetched image Fs4 from the second displacement video frame Fm4, wherein the time period of the first displacement video frame Fm3 is the same with that of the second displacement video frame Fm4. Following that, the flow proceeds to step (f″), the central processor 10a correspondingly generates a measured pattern by subtracting the fourth fetched image Fs4 from the third fetched image Fs3, wherein the measured pattern is a 12×12 matrix of sub-pixels of the displacement frame PP.

By repeating the above steps (d″) to (f″), based on the images the light pen 30 fetched from the first and second displacement video frames Fm3 and Fm4, the central processor 10a can determine the traveling distance, that is, the non-directional displacement resulted from the a continuous touch operation when the user operates the light pen 30. In step (g″), when the user operates the light pen 30, the gravity sensing device 30e simultaneously generates downward gravity direction information S_G by sensing an acceleration direction applied on the light pen by the gravity. In the step (h″), based on the measured traveling distance and the downward gravity direction information S_G, the central processor 10a determines the relative displacement of the light pen 30 moving on the display screen 22. For example, if the image sensor 30d detects that the black and white interlaced chessboard moves toward the gravity direction for one grid, then it means the light pen 30 moves vertically upwards for one sub-pixel distance. If the image sensor 30d detects that the black and white interlaced chessboard moves to the right and perpendicular to the gravity direction for one grid, then it means that the light pen 30 moves to the left horizontally for one sub-pixel distance.

Following step (h″), the flow proceeds to step (i″), the central processor 10a determines whether the user intends to continue the touch operation on the display system 1 and correspondingly determines whether the positioning method exits the state 300. For example, the central processor 10a determines whether to exit the displacement calculation state 300 according to the whether the light pen 30 remains at the “touch state”.

If the light pen 30 remains at the “touch state”, the central processor 10a determines that the user intends to continue the touch operation on the display system 1. Thus, following step (i″), the central processor 10a returns to step (b″) to make the display device 20 take turns to display the first and second displacement video frames (Fm3, Fm4) which carrying the positive displacement frame PP+ and the negative displacement frame PP− information. The central processor 10a continuously determines the relative displacement of the light pen 30 during one continuous touch operation. Thus, the central processor 10a does not need to match and locate the positioning coding patterns PX(I, J) corresponding to a plurality of the to-be-positioned spot AW from the entire coordinate image frame PX repeatedly, so it dramatically reduces the complexity of computation and improves the response time of drawing a continuous trace by the light pen 30.

If the light pen 30 switches to the “non touch state” from the “touch state”, the control device 10 determines that the user intends to terminate the current touch operation on the display system 1. Thus, following step (i″), the control device 10 exits the displacement calculation state 300 and returns to the initial state 100. Meanwhile, the light pen 30 has lost the absolute coordinates of the to-be-positioned spot AW. When the user again operates the light pen 30, the central processor 10a needs to re-enter the initial positioning state 200 to match and locate the positioning coding patterns PX(I, J) corresponding to a plurality of to-be-positioned spots AW from the entire coordinate image frame PX so as to determine the absolute coordinates of the to-be-positioned spot AW. Consequently, more computation will be required.

Through the operations in the initial state 100, the initial positioning state 200 and the displacement calculation state 300, the display system 1 can continuously perform positioning operation on the to-be-positioned spot AW at which the light pen 30 contacts the display screen 22 and continuously detect the traces of continuous operation on the display screen 22 by the light pen 30 so as to implement the display system 1 with touch function.

As illustrated in FIG. 4B, in another embodiment, if the computing power of the central processor 10a is high enough, then the entire flow may only requires two states—the initial state 100 and the initial positioning state 200. After entering the initial positioning state 200, whenever the light pen 30 keeps touching the display screen 22, the central processor 10a keeps determining the absolute coordinates of a plurality of to-be-positioned spot AW by matching the plurality of positioning coding patterns fetched from the display screen 22. Thus, it may be unnecessary to implement “the displacement calculation state 300”.

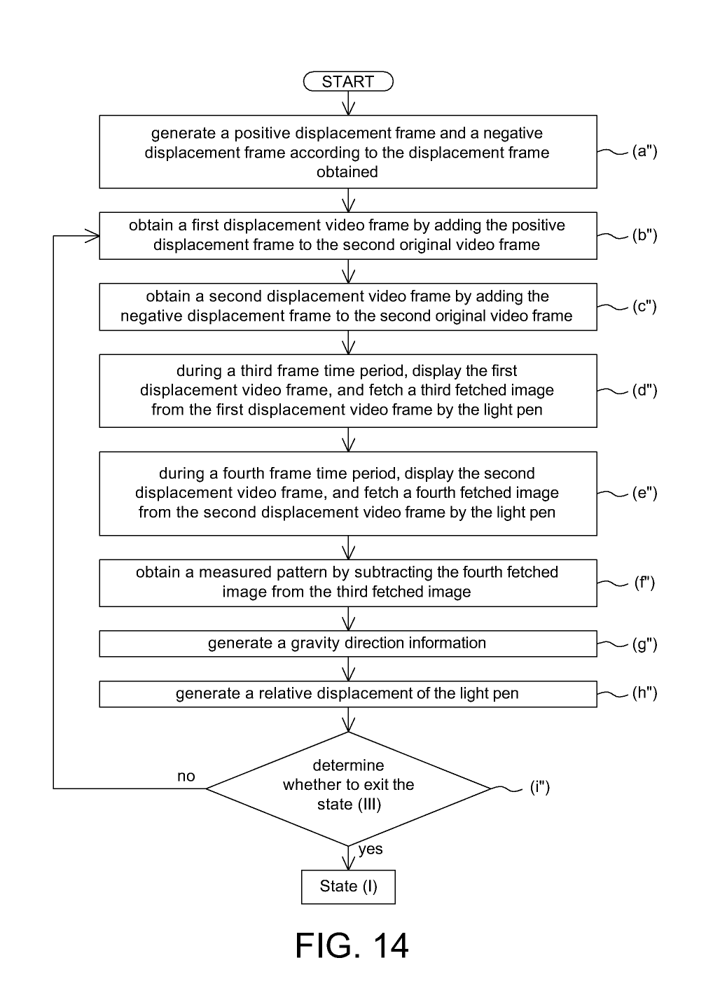

In the above embodiments of the invention, the display system 1 executes the positioning method by using the central processor 10a as a main circuit of the display system 1 for controlling other circuits of the display system 1. However, as illustrated in FIG. 15, in an alternative embodiment, the display system 1′ can perform the positioning method by using the touch panel control unit 10c′. In the present example, the central processor 10a′ is merely an original video signal source which provides an original video frame Fo1 to the touch panel control unit 10c′. The touch panel control unit 10c′ has enough computing power to properly perform various steps defined in the initial state 100, the initial positioning state 200 and the displacement calculation state 300. Thus, based on the original video frame Fo1, the coordinate image frame PX and the displacement image frame PP, the touch panel control unit 10c′ can generate the coordinate video frames and displacement video frames (Fm1 to Fm4), and complete the positioning and displacement calculation of the to-be-positioned spot based on the fetched images Fs1 to Fs4 and the gravity direction information S_G.

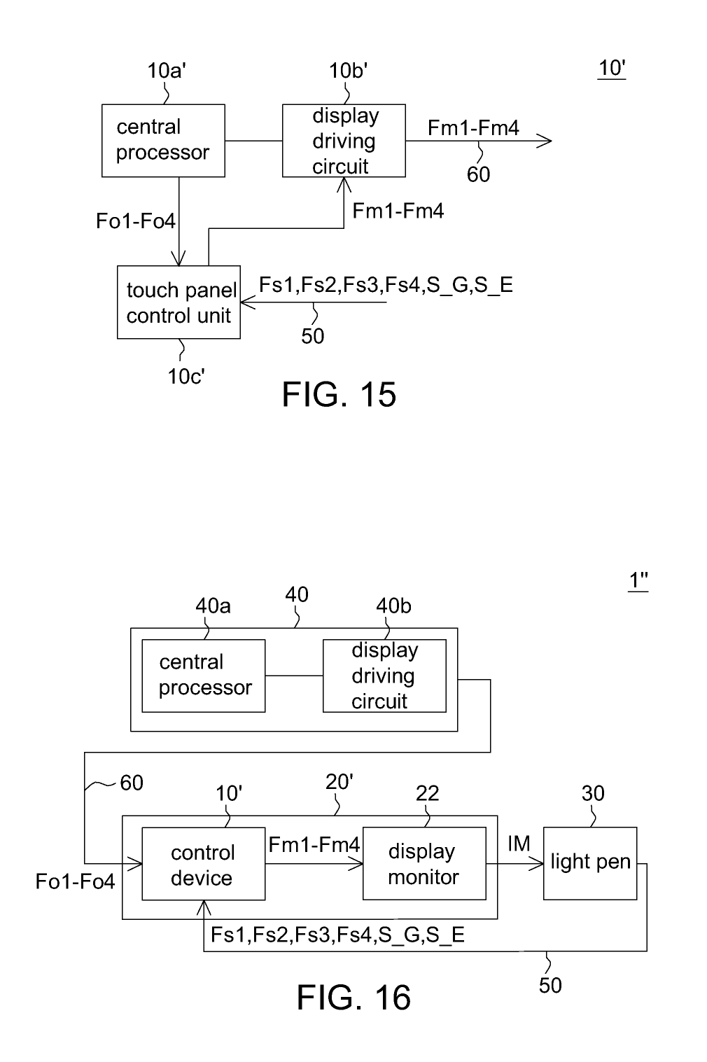

In another embodiment illustrated in FIG. 16, wherein the control device 10″ can also be integrated in the display device 20′. In the present example, the personal computer 40 is an original signal source which provides an original video frame Fo1 to the control device 10″, and the control device 10″ which is integrated in the display device 20′ has enough computing power to properly perform various steps defined in the initial state 100, the initial positioning state 200 and the displacement calculation state 300.

While the invention has been described by way of example and in terms of the preferred embodiment(s), it is to be understood that the invention is not limited thereto. On the contrary, it is intended to cover various modifications and similar arrangements and procedures and the scope of the appended claims therefore should be accorded the broadest interpretation so as to encompass all such modifications and similar arrangements and procedures.

What is claimed is:

1. A positioning method for determining the position of a to-be-positioned spot at which a light pen contacts a display device, wherein the display device comprises a plurality of display areas and has a built-in original coordinate image frame, which comprises a plurality of positioning coding patterns corresponding to the display areas, so that each of the display areas corresponds to a unique positioning coding pattern, which denotes the position coordinates of a corresponding display area, the display device displays a first original video frame for the user to view, and the positioning method comprises:
generating a positive coordinate image frame and a negative coordinate image frame corresponding to the positive coordinate image frame according to the original coordinate image frame obtained by subtracting the negative coordinate image frame from the positive coordinate image frame;
obtaining a first display frame by adding the positive coordinate image frame to the first original video frame;
obtaining a second display frame by adding the negative coordinate image frame to the first original video frame;
during a first frame time period, displaying the first display frame by the display device, and fetching a first fetched image corresponding to the to-be-positioned spot from the first display frame by the light pen;
during a second frame time period, displaying the second display frame by the display device, and fetching a second fetched image corresponding to the to-be-positioned spot from the second display frame by the light pen;
obtaining a to-be-positioned coding pattern by subtracting the second fetched image from the first fetched image; and
matching a positioning coding pattern identical to the to-be-positioned coding pattern among the positioning coding patterns and using the corresponding position coordinates of the identical positioning coding pattern as the position coordinates of the to-be-positioned spot.

2. The positioning method according to claim 1, wherein in the step of generating the to-be-positioned coding pattern, the to-be-positioned coding pattern is generated according to a difference in gray level between corresponding pixels of the first fetched image and the second fetched image.

3. The positioning method according to claim 1, when a relative displacement of the light pen is to be detected, the positioning method further comprises:
the display device has a built-in displacement frame, the light pen comprises a gravity sensing device, the displacement frame comprises a plurality of displacement coding patterns arranged in cycles, the frequency of the displacement coding pattern between any two display areas denotes the interval between the two display areas, the display device displays a second original video frame, and the positioning method comprises:
generating a positive displacement frame and a negative displacement frame corresponding to the positive displacement frame according to the displacement frame obtained by subtracting the negative displacement frame from the positive displacement frame;
(1) obtaining a third display frame by adding the positive displacement frame to the second original video frame;
(2) obtaining a fourth display frame by adding the negative displacement frame to the second original video frame;
(3) during a third frame time period, displaying the third display frame, and fetching a third fetched image from the third display frame by the light pen;
(4) during a fourth frame time period, displaying the fourth display frame, and fetching a fourth fetched image from the fourth display frame by the light pen;
(5) obtaining a measured pattern by subtracting the fourth fetched image from the third fetched image;
repeating the above steps (1) to (5), wherein the light pen fetches a plurality of measured patterns and generates a measured displacement according to the measured patterns;
generating a gravity direction information by the gravity sensing device; and
generating a relative displacement of the light pen according to the measured displacement and the gravity direction information.

4. The positioning method according to claim 3, wherein the front end of the light pen further comprises a touch switch, and the positioning method further comprises:
displaying the coordinate image frame by the display device to determine the position coordinates of the to-be-positioned spot when the touch switch changes to the “touch state” from the “non-touch state” but before the “touch state” reaches a predetermined time period; and
displaying the displacement frame by the display device to determine a relative displacement of the light pen after the touch switch has remained at the “touch state” for the predetermined time period.

5. The positioning method according to claim 3, wherein the light pen further comprises a lens and an image sensor, and when the front end of the light pen contacts the display device, a display device frame is formed on the image sensor by the lens, and the positioning method further comprises:
displaying the coordinate video frame by the display device to determine the position coordinates of the to-be-positioned spot when the image sensor determines that the display device frame changes to the “image successfully focused on the image sensor” state from the “image cannot be formed on the image sensor” state but before the formation of image reaches a predetermined time period; and
displaying the displacement frame by the display device to determine a relative displacement of the light pen when the image sensor determines that the display device frame has remained at the “image successfully focused on the image sensor” state for the predetermined time period.

6. The positioning method according to claim 3, wherein the positioning method further comprises:
displaying the coordinate video frame by the display device to determine the position coordinates of the to-be-positioned spot before the display device determines the position coordinates of the to-be-positioned spot; and
displaying the displacement frame by the display device to determine a relative displacement of the light pen after the display device has determined the position coordinates of the to-be-positioned spot.

7. The positioning method according to claim 1, wherein the step of generating the first display frame further comprises:
the original gray level of each pixel of the first original video frame is an M-bit data, wherein the change in original gray level is within an original range of (0 to 2^{M}−1);
generating a first adjustment video frame according to the first original video frame, so that the change in adjusted gray level of each pixel of the first adjustment video frame is within an adjustment range of (N to 2^{M}−N−1);
the change in gray level of the pixels of the positive coordinate image frame is within a range of (0 to N);
the change in gray level of the pixels of the negative coordinate image frame is within a range of (−N to 0);
when the positive coordinate image frame is added to the first adjustment video frame, the change in gray level after frame adding is within the range of (N to 2^{M}−1) but is smaller than the original range of (0 to 2^{M}−1); and
when the negative coordinate image frame is added to the first adjustment video frame, the change in gray level after frame adding is within the range of (0 to 2^{M}−N−1) but is smaller than the original range of (0 to 2^{M}−1).

8. A method for determining a relative displacement of a light pen in contact with a display device, wherein the display device comprises a plurality of display areas and has a built-in displacement frame, the light pen comprises a gravity sensing device, the displacement frame comprises a plurality of displacement coding patterns arranged in cycles, the frequency of the displacement coding pattern between any two display areas denotes the interval between the two display areas, the display device displays a second original video frame, and the positioning method comprises:
generating a positive displacement frame and a negative displacement frame corresponding to the positive displacement frame according to the displacement frame obtained by subtracting the negative displacement frame from the positive displacement frame;
(1) obtaining a third display frame by adding the positive displacement frame to the second original video frame;
(2) obtaining a fourth display frame by adding the negative displacement frame to the second original video frame;
(3) during a third frame time period, displaying the third display frame, and fetching a third fetched image from the third display frame by the light pen;
(4) during a fourth frame time period, displaying the fourth display frame, and fetching a fourth fetched image from the fourth display frame by the light pen;
(5) obtaining a measured pattern by subtracting the fourth fetched image from the third fetched image;
repeating the above steps (1) to (5), wherein the light pen fetches a plurality of measured patterns and generates a measured displacement according to the measured patterns;
generating a gravity direction information by the gravity sensing device; and
generating a relative displacement of the light pen according to the measured displacement and the gravity direction information.

9. The positioning method according to claim 8, wherein the step of generating the third display frame further comprises:
the original gray level of each pixel of the second original video frame is an M-bit data, wherein the change in original gray level is within an original range of (0 to 2^{M}−1);
generating a second adjustment video frame according to the second original video frame, wherein the change in adjusted gray level of each pixel of the second adjustment video frame is within an adjustment range of (N to 2^{M}−N−1);
the change in gray level of the positive displacement frame pixels is within a range of (0 to N);
the change in gray level of the negative displacement frame pixels is within a range of (−N to 0);
when the positive displacement frame is added to the second adjustment video frame, the change in gray level after frame adding is within the range of (N to 2^{M}−1) but is smaller than the original range of (0 to 2^{M}−1);
when the negative displacement frame is added to the second adjustment video frame, the change in gray level after frame adding is within the range of (0 to 2^{M}−N−1) but is smaller than the original range of (0 to 2^{M}−1).

10. A positioning method for determining the position of a to-be-positioned spot at which a light pen contacts a display device, wherein the display device comprises a plurality of display areas and has a built-in original coordinate image frame, which comprises a plurality of positioning coding patterns respectively corresponding to the display areas, so that each of the display areas corresponding to the same horizontal position corresponds to a unique positioning coding pattern, which denotes the horizontal coordinate of the corresponding display area, the display device displays a first original video frame for the user to view, and the positioning method comprises:
generating a positive coordinate image frame and a negative coordinate image frame corresponding to the positive coordinate image frame according to the original coordinate image frame obtained by subtracting the negative coordinate image frame from the positive coordinate image frame;
obtaining a first display frame by adding the positive coordinate image frame to the first original video frame;
obtaining a second display frame by adding the negative coordinate image frame to the first original video frame;
during a first frame time period, displaying the first display frame by the display device, and fetching a first fetched image corresponding to the to-be-positioned spot from the first display frame by the light pen;
during a second frame time period, displaying the second display frame by the display device, and fetching a second fetched image corresponding to the to-be-positioned spot from the second display frame by the light pen;
obtaining a to-be-positioned coding pattern by subtracting the second fetched image from the first fetched image;
matching a positioning coding pattern identical to the to-be-positioned coding pattern among the positioning coding patterns, and using the corresponding position coordinates of the identical positioning coding pattern as the position coordinates of the to-be-positioned spot so as to identify a horizontal coordinate of a to-be-positioned spot corresponding to the to-be-positioned coding pattern;
sensing either of a first image update starting time of the first fetched image and a second image update starting time of the second fetched image; and
locating a vertical coordinate of the to-be-positioned spot corresponding to the fetched image according to the time relationship between either of the first image update starting time and the second image update starting time and a frame update initial point of the display device.

11. The positioning method according to claim 10, wherein in the step of generating the to-be-positioned coding pattern, the to-be-positioned coding pattern is generated according to a difference in gray level between corresponding pixels of the first fetched image and the second fetched image.

12. The positioning method according to claim 10, when a relative displacement of the light pen is to be detected, the positioning method further comprises:
the display device has a built-in displacement frame, the light pen comprises a gravity sensing device, the displacement frame comprises a plurality of displacement coding patterns arranged in cycles, the frequency of the displacement coding pattern between any two display areas denotes the interval between the two display areas, the display device displays a second original video frame, and the positioning method comprises:
generating a positive displacement frame and a negative displacement frame corresponding to the positive displacement frame according to the displacement frame obtained by subtracting the negative displacement frame from the positive displacement frame;
(1) obtaining a third display frame by adding the positive displacement frame to the second original video frame;
(2) obtaining a fourth display frame by adding the negative displacement frame to the second original video frame;
(3) during a third frame time period, displaying the third display frame, and fetching a third fetched image from the third display frame by the light pen;
(4) during a fourth frame time period, displaying the fourth display frame, and fetching a fourth fetched image from the fourth display frame by the light pen;
(5) obtaining a measured pattern by subtracting the fourth fetched image from the third fetched image;
repeating the above steps (1) to (5), wherein the light pen fetches a plurality of measured patterns and generates a measured displacement according to the measured patterns;
generating a gravity direction information by the gravity sensing device; and
generating a relative displacement of the light pen according to the measured displacement and the gravity direction information.

13. The positioning method according to claim 12, wherein the front end of the light pen further comprises a touch switch, and the positioning method further comprises:
displaying the coordinate video frame by the display device to determine the position coordinates of the to-be-positioned spot after the touch switch changes to the “touch state” from the “non-touch state” but before the “touch state” reaches a predetermined time period; and
displaying the displacement frame by the display device to determine a relative displacement of the light pen after the touch switch has maintained the “touch state” for the predetermined time period.

14. The positioning method according to claim 12, wherein the light pen further comprises a lens and an image sensor, and when the front end of the light pen contacts the display device, a display device frame is formed on the image sensor by the lens, and the positioning method further comprises:
displaying the coordinate video frame by the display device to determine the position coordinates of the to-be-positioned spot when the image sensor determines that the display device frame changes to the “image successfully focused on the image sensor” state from the “image cannot be formed on the image sensor” state but before the formation of image reaches a predetermined time period; and
displaying the displacement frame by the display device to determine a relative displacement of the light pen when the image sensor determines that the display device frame has remained at the “image successfully focused on the image sensor” state for the predetermined time period.

15. The positioning method according to claim 12, wherein the positioning method further comprises:
displaying the coordinate video frame by the display device to determine the position coordinates of the to-be-positioned spot before the display device determines the position coordinates of the to-be-positioned spot; and
displaying the displacement frame by the display device to determine a relative displacement of the light pen after the display device has determined the position coordinates of the to-be-positioned spot.

16. The positioning method according to claim 10, wherein the step of generating the first display frame further comprises:
the original gray level of each pixel of the first original video frame is an M-bit data, wherein the change in original gray level is within an original range of (0 to 2^{M}−1);
generating a first adjustment video frame according to the first original video frame, so that the change in adjusted gray level of each pixel of the first adjustment video frame is within an adjustment range of (N to 2^{M}−N−1);
the change in gray level of the pixels of the positive coordinate image frame is within a range of (0 to N);
the change in gray level of the pixels of the negative coordinate image frame is within a range of (−N to 0);
when the positive coordinate image frame is added to the first adjustment video frame, the change in gray level after frame adding is within the range of (N to 2^{M}−1) but is smaller than the original range of (0 to 2^{M}−1); and
when the negative coordinate image frame is added to the first adjustment video frame, the change in gray level after frame adding is within the range of (0 to 2^{M}−N−1) but is smaller than the original range of (0 to 2^{M}−1).

17. A display system for displaying a first original video frame for the user to view, wherein the display system comprises:
a display device comprising a plurality of display areas;
a light pen; and
a control device having a built-in original coordinate image frame, which comprises a plurality of positioning coding patterns respectively corresponding to the a plurality of display areas, so that each of the display areas corresponds to a unique positioning coding pattern, which denotes the position coordinates of the corresponding display area, the control device controls the display device and the light pen to execute a positioning procedure comprising:
generating a positive coordinate image frame and a negative coordinate image frame corresponding to the positive coordinate image frame according to the original coordinate image frame obtained by subtracting the negative coordinate image frame from the positive coordinate image frame;
obtaining a first display frame by adding the positive coordinate image frame to the first original video frame;
obtaining a second display frame by adding the negative coordinate image frame to the first original video frame;
during a first frame time period, driving the display device to display the first display frame and driving the light pen to fetch a first fetched image corresponding to the to-be-positioned spot from the first display frame;
during a second frame time period, driving the display device to display the second display frame and driving the light pen to fetch a second fetched image corresponding to the to-be-positioned spot from the second display frame;
obtaining a to-be-positioned coding pattern by subtracting the second fetched image from the first fetched image; and
matching a positioning coding pattern identical to the to-be-positioned coding pattern among the positioning coding patterns, and using the corresponding position coordinates of the identical positioning coding pattern as the position coordinates of the to-be-positioned spot.

18. The display system according to claim 17, wherein in the step of generating the to-be-positioned coding pattern, the to-be-positioned coding pattern is generated according to a difference in gray level between corresponding pixels of the first fetched image and the second fetched image.

19. The display system according to claim 17, when a relative displacement of the light pen is to be detected, and the positioning procedure further comprises:
the display device has a built-in displacement frame, the light pen comprises a gravity sensing device, the displacement frame comprises a plurality of displacement coding patterns arranged in cycles, the frequency of the displacement coding pattern between any two display areas denotes the interval between the two display areas, the display device displays a second original video frame, the positioning procedure comprises:
generating a positive displacement frame and a negative displacement frame corresponding to the positive displacement frame according to the displacement frame obtained by subtracting the negative displacement frame from the positive displacement frame;
(1) obtaining a third display frame by adding the positive displacement frame to the second original video frame;
(2) obtaining a fourth display frame by adding the negative displacement frame to the second original video frame;
(3) during a third frame time period, displaying the third display frame, and fetching a third fetched image from the third display frame by the light pen;
(4) during a fourth frame time period, displaying the fourth display frame, and fetching a fourth fetched image from the fourth display frame by the light pen;
(5) obtaining a measured pattern by subtracting the fourth fetched image from the third fetched image;
repeating the above steps (1) to (5), wherein the light pen fetches a plurality of measured patterns and generates a measured displacement according to the measured patterns;
generating a gravity direction information by the gravity sensing device; and
generating a relative displacement of the light pen according to the measured displacement and the gravity direction information.

20. The display system according to claim 19, wherein the front end of the light pen further comprises a touch switch, and the positioning procedure further comprises:
displaying the coordinate video frame by the display device to determine the position coordinates of the to-be-positioned spot after the touch switch has changed to the “touch state” from the “non-touch state” for a predetermined time period; and
displaying the displacement frame by the display device to determine a relative displacement of the light pen after the touch switch has remained at the “touch state” for the predetermined time period.

21. The display system according to claim 19, wherein the light pen further comprises a lens and an image sensor, and when the front end of the light pen contacts the display device, a display device frame is formed on the image sensor by the lens, and the positioning method further comprises:
displaying the coordinate video frame by the display device to determine the position coordinates of the to-be-positioned spot when the image sensor determines that the display device frame from the “image cannot be formed on the image sensor” state changes to the “image successfully focused on the image sensor” state and after the formation of image has maintained for a predetermined time period; and
displaying the displacement frame by the display device to determine a relative displacement of the light pen when the image sensor determines that the display device frame has remained at the “image successfully focused on the image sensor” state for the predetermined time period.

22. The display system according to claim 19, wherein the positioning procedure further comprises:
displaying the coordinate video frame by the display device to determine the position coordinates of the to-be-positioned spot before the display device determines the position coordinates of the to-be-positioned spot; and
displaying the displacement frame by the display device to determine a relative displacement of the light pen after the display device has determined the position coordinates of the to-be-positioned spot.

23. The display system according to claim 17, wherein in the positioning procedure, the generation of the first display frame further comprises:
the original gray level of each pixel of the first original video frame is an M-bit data, wherein the change in original gray level is within an original range of (0 to 2^{M}−1);
generating a first adjustment video frame according to the first original video frame, so that the change in adjusted gray level of each pixel of the first adjustment video frame is within an adjustment range of (N to 2^{M}−N−1);
the change in gray level of the pixels of the positive coordinate image frame is within a range of (0 to N);
the change in gray level of the pixels of the negative coordinate image frame is within a range of (−N to 0);
when the positive coordinate image frame is added to the first adjustment video frame, the change in gray level after frame adding is within the range of (N to 2^{M}−1) but is smaller than the original range of (0 to 2^{M}−1); and
when the negative coordinate image frame is added to the first adjustment video frame, the change in gray level after frame adding is within the range of (0 to 2^{M}−N−1) but is smaller than the original range of (0 to 2^{M}−1).

24. A display system for displaying a first original video frame for the user to view, wherein the display system comprises:
a display device comprising a plurality of display areas;
a light pen; and
a control device having a built-in original coordinate image frame, which comprises a plurality of positioning coding patterns respectively corresponding to the a plurality of display areas, so that each of the display areas corresponds to a unique positioning coding pattern, which denotes the position coordinates of the corresponding display area, the control device controls the display device and the light pen to execute a positioning procedure comprising:
generating a positive coordinate image frame and a negative coordinate image frame corresponding to the positive coordinate image frame according to the original coordinate image frame obtained by subtracting the negative coordinate image frame from the positive coordinate image frame;
obtaining a first display frame by adding the positive coordinate image frame to the first original video frame;
obtaining a second display frame by adding the negative coordinate image frame to the first original video frame;
during a first frame time period, displaying the first display frame by the display device, and fetching a first fetched image corresponding to the to-be-positioned spot from the first display frame by the light pen;
during a second frame time period, displaying the second display frame by the display device, and fetching a second fetched image corresponding to the to-be-positioned spot from the second display frame by the light pen;
obtaining a to-be-positioned coding pattern by subtracting the second fetched image from the first fetched image;
matching a positioning coding pattern identical to the to-be-positioned coding pattern among the positioning coding patterns, and using the corresponding position coordinates of the identical positioning coding pattern as the position coordinates of the to-be-positioned spot so as to identify a horizontal coordinate of a to-be-positioned spot corresponding to the to-be-positioned coding pattern;
sensing either of a first image update starting time of the first fetched image and a second image update starting time of the second fetched image; and
locating a vertical coordinate of the to-be-positioned spot corresponding to the fetched image according to the time relationship between either of the first image update starting time and the second image update starting time and a frame update initial point of the display device.

25. The display system according to claim 24, wherein during the generation the to-be-positioned coding pattern, the to-be-positioned coding pattern is generated according to a difference in gray level between corresponding pixels of the first fetched image and the second fetched image.

26. The display system according to claim 24, when a relative displacement of the light pen is to be detected, the positioning procedure further comprises:
the display device has a built-in displacement frame, the light pen comprises a gravity sensing device, the displacement frame comprises a plurality of displacement coding patterns arranged in cycles, the frequency of the displacement coding pattern between any two display areas denotes the interval between the two display areas, the display device displays a second original video frame, and the positioning procedure comprises:
generating a positive displacement frame and a negative displacement frame corresponding to the positive displacement frame according to the displacement frame obtained by subtracting the negative displacement frame from the positive displacement frame;
(1) obtaining a third display frame by adding the positive displacement frame to the second original video frame;
(2) obtaining a fourth display frame by adding the negative displacement frame to the second original video frame;
(3) during a third frame time period, displaying the third display frame, and fetching a third fetched image from the third display frame by the light pen;
(4) during a fourth frame time period, displaying the fourth display frame, and fetching a fourth fetched image from the fourth display frame by the light pen;
(5) obtaining a measured pattern by subtracting the fourth fetched image from the third fetched image;
repeating the above steps (1) to (5), wherein the light pen fetches a plurality of measured patterns and generates a measured displacement according to the measured patterns;
generating a gravity direction information by the gravity sensing device; and
generating a relative displacement of the light pen according to the measured displacement and the gravity direction information.

27. The display system according to claim 26, wherein the front end of the light pen further comprises a touch switch, and the positioning procedure further comprises:
displaying the coordinate video frame by the display device to determine the position coordinates of the to-be-positioned spot after the touch switch changes to the “touch” state from “non-touch state” for a predetermined time period; and
displaying the displacement frame by the display device to determine a relative displacement of the light pen when the touch switch has remained at the “touch state” for the predetermined time period.

28. The display system according to claim 26, wherein the light pen further comprises a lens and an image sensor, when the front end of the light pen contacts the display device, a display device frame is formed on the image sensor by the lens, and the positioning method further comprises:
displaying the coordinate video frame by the display device to determine the position coordinates of the to-be-positioned spot when the image sensor determines that the display device frame changes to the “image successfully focused on the image sensor” state from the “image cannot be formed on the image sensor” state and the formation of image has maintained for a predetermined time period; and
displaying the displacement frame by the display device to determine a relative displacement of the light pen when the image sensor determines that the display device frame has remained at the “image successfully focused on the image sensor” state for the predetermined time period.

29. The display system according to claim 26, wherein the positioning procedure further comprises:
displaying the coordinate video frame by the display device to determine the position coordinates of the to-be-positioned spot before the display device determines the position coordinates of the to-be-positioned spot; and
displaying the displacement frame by the display device to determine a relative displacement of the light pen after the display device has determined the position coordinates of the to-be-positioned spot.

30. The display system according to claim 24, wherein in the positioning procedure, the generation of the first display frame further comprises:
the original gray level of each pixel of the first original video frame is an M-bit data, wherein the change in original gray level is within an original range of (0 to 2^{M}−1);
generating a first adjustment video frame according to the first original video frame, so that the change in adjusted gray level of each pixel of the first adjustment video frame is within an adjustment range of (N to 2^{M}−N−1);
the change in gray level of the pixels of the positive coordinate image frame is within a range of (0 to N);
the change in gray level of the pixels of the negative coordinate image frame is within a range of (−N to 0);
when the positive coordinate image frame is added to the first adjustment video frame, the change in gray level after frame adding is within the range of (N to 2^{M}−1) but is smaller than the original range of (0 to 2^{M}−1); and
when the negative coordinate image frame is added to the first adjustment video frame, the change in gray level after frame adding is within the range of (0 to 2^{M}−N−1) but is smaller than the original range of (0 to 2^{M}−1).
